(19) United States
(12) Patent Application Publication
(10) Pub. No.: US 2015/0008868 A1
(43) Pub. Date: Jan. 8, 2015

(54) Cell Hotel

(71) Applicant: Virginia Burton Whitehead, (US)

(72) Inventor: Virginia Burton Whitehead, (US)

(21) Appl. No.: 13/936,158

(22) Filed: Jul. 6, 2013

(51) Int. Cl. H02J 7/00

(52) U.S. Cl. CPC H02J 7/0052
USPC 320/107

(57) ABSTRACT

This invention is directed at utility and process. In today's overcrowded classrooms, there is an urgent need to reduce all unnecessary distractions. A large number of students carry a cell phone to school each day. Some, not all, of these devices, may also get the internet. Many teachers believe, and research has demonstrated, that the cell phone can cause major distractions during instruction. In large classes, where complete supervision is difficult, students may be free to surf the net, take photos of tests, and disturb students in other classes by texting. Schools have not found a solution to this problem. Parents support their children having a cell phone at school. School violence and other emergencies have raised parental concern and a need for instant contact with their children. Misuse of phones during class has lead to draconian measures which anger the students and their parents. Administrative time is now consumed by the issue of cell phone misuse in the classroom.

The Cell Hotel gives the authoritative power back to the teacher by providing a positive, easy, and secure way to store the student cell phone during instructional time. The Cell Hotel is a kit. The kit contains everything a classroom teacher needs to get started eliminating the distractions brought on by student cell phones.

### SUMMARY

Methods and systems are provided for classroom use. The kit includes: 40 cell beds (phone pockets) each unique and with a matching bracelet. Dual cellular chargers (solar and DC) allow some phones to charge while stored. A classroom recording system is contained in Binder #1. Current and developing research on the topic of cell use and distracted learning is contained in Binder #2, along with a summary of said research. A case with a lock and two keys, a handle and a strap to the case, make the kit complete.

### SPECIFICATIONS

This invention is to be made, sold, and used as a kit.

The kit contains:

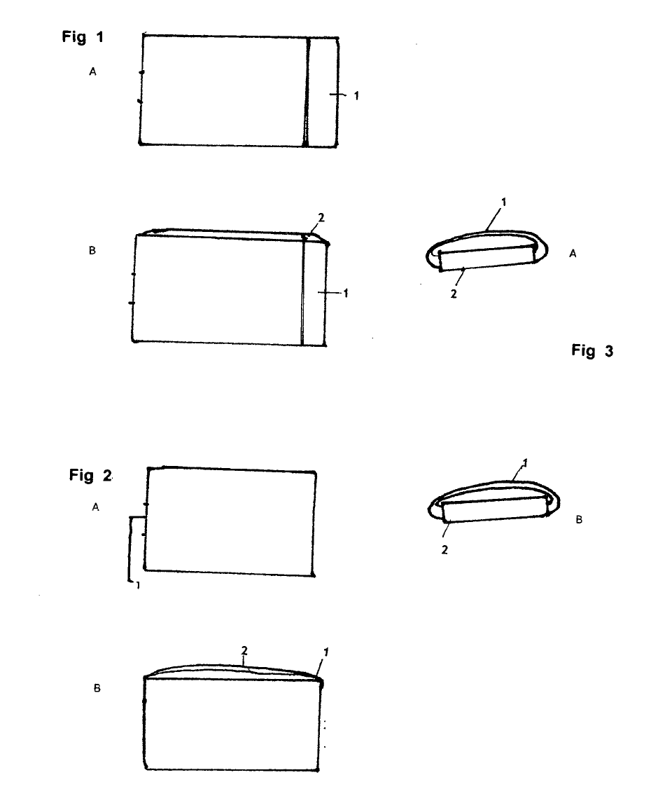

35 “regular beds” (4″×6″) and 5 “extra-long beds” (4″×7″) see FIGS. 1 and 2

The beds are made of 9″×12″ felt pieces, each with a unique color and/or print, the beds have a pocket design which completely covers and protects the student's phone. Each is soft and easy to identify because of the unique color and/or design. Each bed has a small (1½″) opening; this allows the phone to stay in bed with charger wire connected

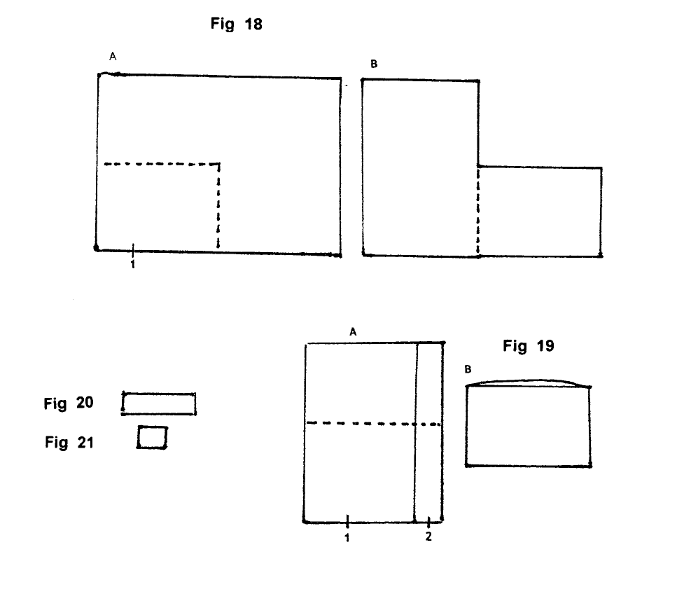

FIG. 2 A 1. The regular size has a second pocket FIGS. 2 B 1 & 2 for earbuds and/or a personal stereo. The extra-long model is a single pocket design. The 1″ ‘extension on the extra-long model is made of knit FIG. 1 A 1. The extra-long beds are necessary for larger phones or phones with protective covers. The majority of student phones will fit in the regular bed. All beds are made from an eco-product that is soft yet durable, anti-microbial, and washable. FIGS. 18, 19, 20, & 21 both the bed and the wristband.

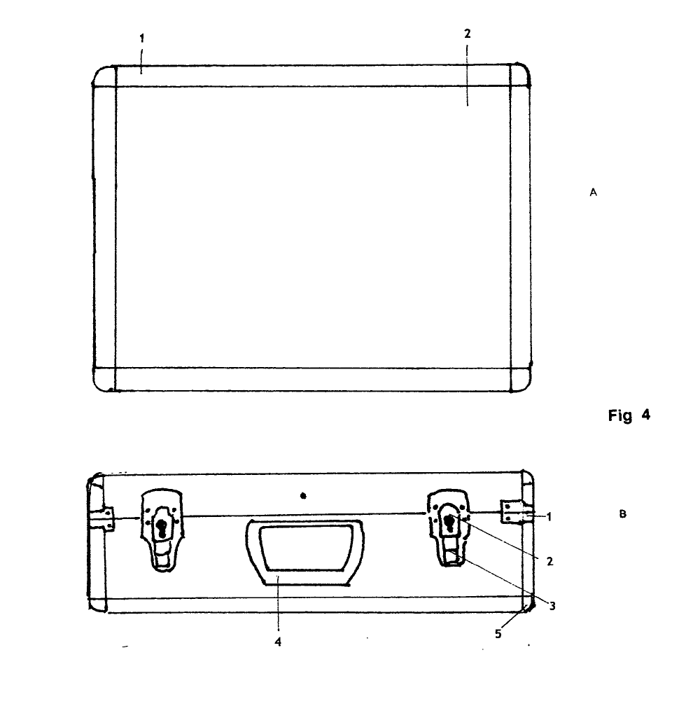

40 matching wristbands FIGS. 3 A and 3 B

Each pocket contains a matching felt elasticized (FIGS. 3 A 2 and 3 B 2) wristbands to be worn by the student while phone is stored or “checked-in”. The matched articles (bed and wristband) are assigned per student for the term, and each time the phone is checked-in, the wristband is used to claim the phone at check-out.

Two purchased solar powered phone chargers and 12 adaptors. FIGS. 15 A, B, C & D.

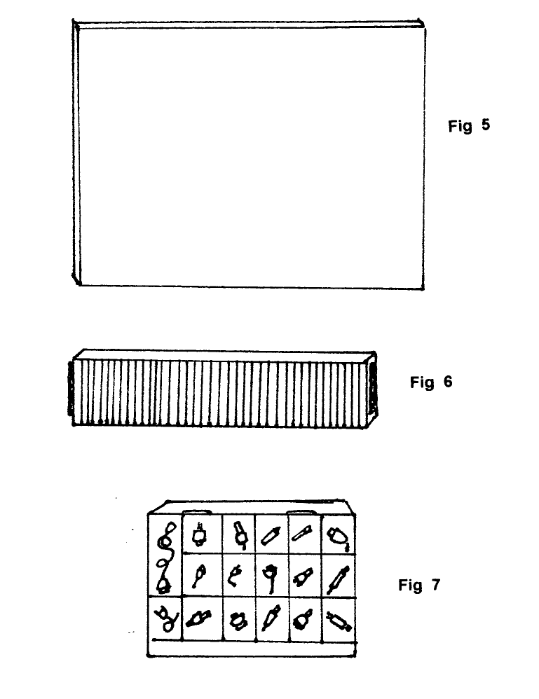

FIG. 15 A shows the device with front panel solar board FIG. 15 A 1. The charger can also be charged through regular electrical outlet FIG. 15 B. The phone chargers are made available to the students on a first come first serve basis. The system is not intended to provide a charge for every students phone while checked in. FIGS. 15 A B, C, D show the charger details. FIG. 15 C 1 is switch button, 2 is solar works display, 3 is usb output display, 4 is LED touch 5 is usb port, 6 is output switch, 7 is usb 2.0 port, 8 is capacity display, and 9 is solar board. A purchased plastic box which measures 10½″×7″×1¾″ and is made of clear plastic throughout with a lid that is attached to the container by a plastic hinge and has dividers so each adaptor has a space FIG. 7. The spaces are all clearly labeled. Adaptors included are: micro usb, mini usb, Sony Ericsson, Nokia, Samsung, and Apple.

The phone charger units are stored in a soft cover that is unique in fabric color and design,

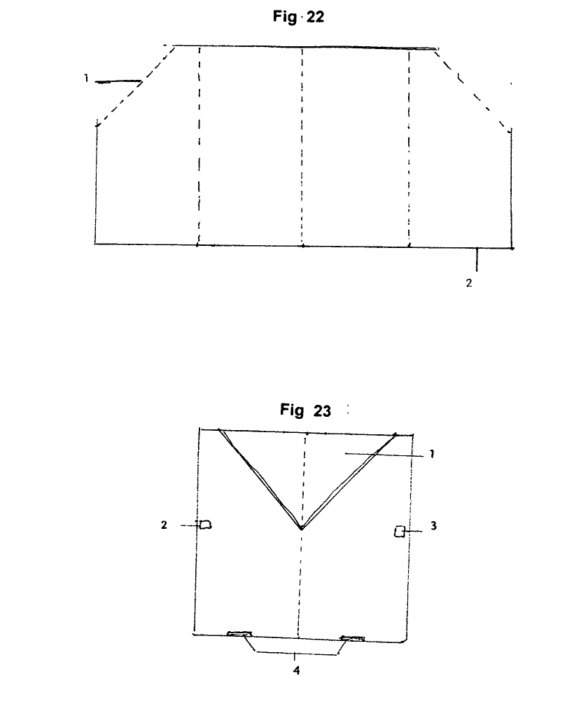

FIG. 14. This cover is similar in size to cell bed (4″×6½″ when closed). The charger cover is designed to hold two charger units side-by-side as it opens up to 8″×6½″, FIG. 23. The design allows for charger wires to pass through the bottom of the cover FIG. 14 A 3. Velcro pieces are sewn in place on top surface of each pocket FIG. 14 1. The cover closes when not in use. FIGS. 14 A 1. Velcro is used to hold the bed in a folded state FIG. 14 B 1.

Along with the chargers, instructions for the chargers are also contained in each pocket, FIG. 14 A 2.

### The Cell Hotel Case

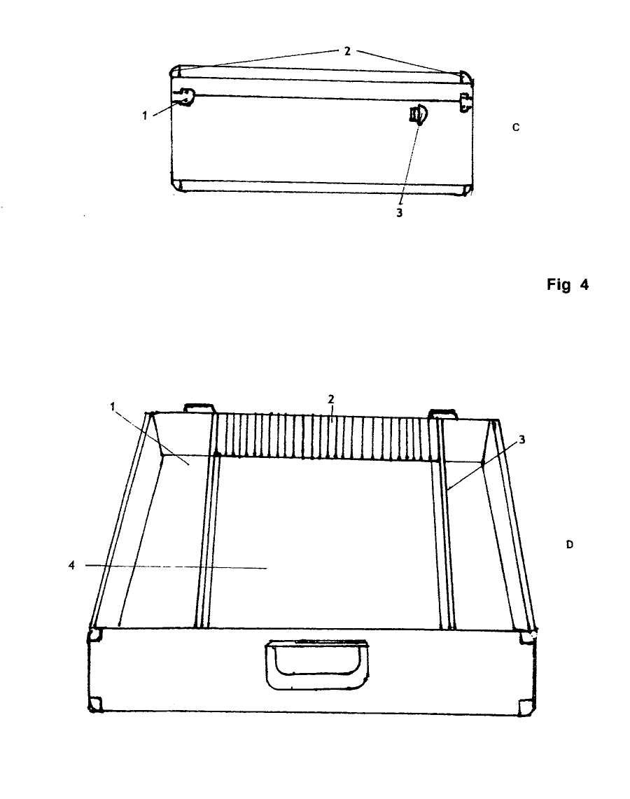

The purchased case measures 14″×18″'6″, FIGS. 4 A, B, C & D.

The exterior of the case is aluminum. The edges are a brushed aluminum FIG. 4 A 1, and the faces are a corrugated finish FIG. 4 A 2. The case has 2 locking latches FIGS. 4 B 2 and FIG. 4 B 3. The case comes with 2 identical keys, FIG. 12. The case has a sturdy plastic handle, FIG. 4 B 4. The eight outside corners have a protective plastic piece

FIG. 4 B 5 & FIG. 4 C 2. Where top and bottom of case come together there are 4 protective metal brackets FIGS. 4 B 1 & 5. and FIG. 4 C 2. FIG. 4 C is a side view of the case showing aforementioned brackets and corners.

The D ring for attaching the strap is shown in FIG. 4 C 3.

The inside of the case is lined with soft foam and a soft black fabric, FIG. 4D. The inside of the case has ½″ wide dividers which are adjustable, FIG. 4 D 3 and FIG. 6. There is one large center section measuring 9″×13″, FIG. 4 D 4. The two side sections each measure 3½×13″.

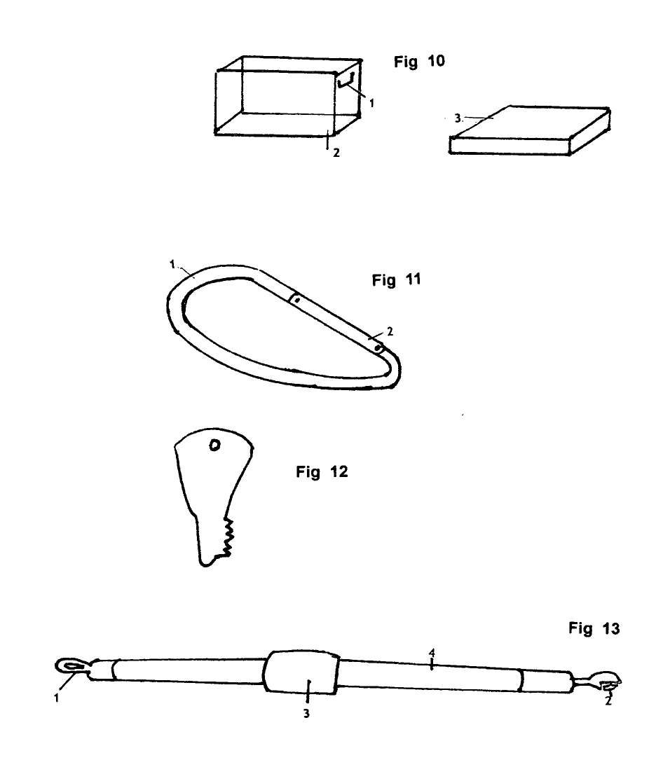

FIG. 4 D 1. Each of these sections holds 20 empty beds. In the center section is the plastic adaptor box FIG. 7, and a small plastic box measuring 3½″×2½″×2″, FIG. 10 A & B. This small box with lid contains the two keys to the case, held together on a purchased key ring as shown in FIG. 11. The lid of the small key box is detachable and there are two swinging latches FIGS. 10 A 1 & 3 to hold the lid on the box. There is a covered foam pad inserted between the top compartment and the bottom compartment of the case, FIG. 5.

The foam pad measures 12½″×17½″×1″. Covered in soft fabric, the pad serves to keep the case contents in place if the case is closed and turned on its side.

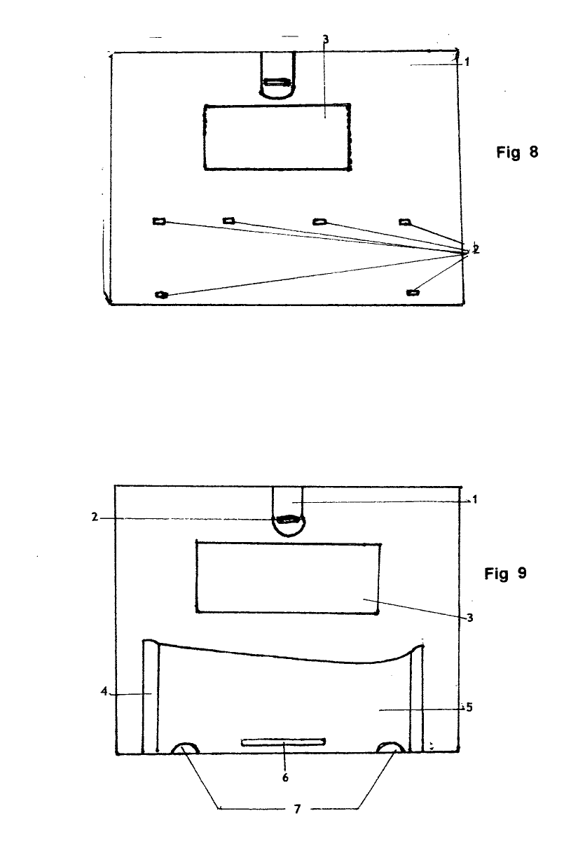

Attached to the inside of the top of the case (behind the pad), FIG. 8, 1 & FIG. 9 there is a velcro (see FIG. 8 2) mounted pouch FIG. 9 5. The pouch measures 14½″×6″ and runs lengthwise, FIG. 9 5. The front of the pouch is elasticized, FIG. 9. This pouch holds the chargers when they are in use. There is a slit at the bottom of this pouch through which the adaptors can attach to the phones as the phones are charged, FIG. 9 6. The slit is 4″ long.

Above the charger pouch is a sign measuring 3½″×9½″×⅝″ and reads “Turn off cell phone” FIG. 8 3 and FIG. 9 3. It is mounted 2½″ from the inside front (top when open) so that when the lid is up, the sign can easily be read. It is centered 4″ from each side of the top of the case and is glued down. There is a tab with turning center and it hangs in front of pad when pad is up, FIG. 9 2. Two plastic pieces holds pad in at the bottom, FIG. 9 7.

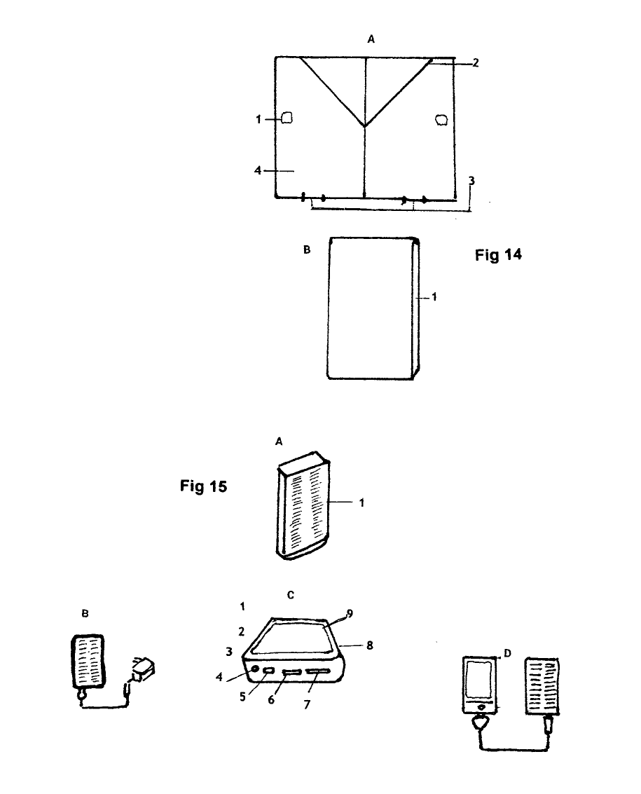

There is enough room in this case to hold approximately 40 phones. If necessary, the case can be locked with the key when security is an issue, or locked and transported in situations where teacher and students must move out quickly, such as an evacuation or a room switch. A strap is provided for extra carrying ease, FIG. 13. The strap is adjustable to 42″ and has a 1¾″ soft shoulder protector, FIG. 13 3. The strap attaches to the D-rings on the exterior of the case, FIG. 4 C 3 with two strap hooks, FIG. 13 1 & 2.

### Binders

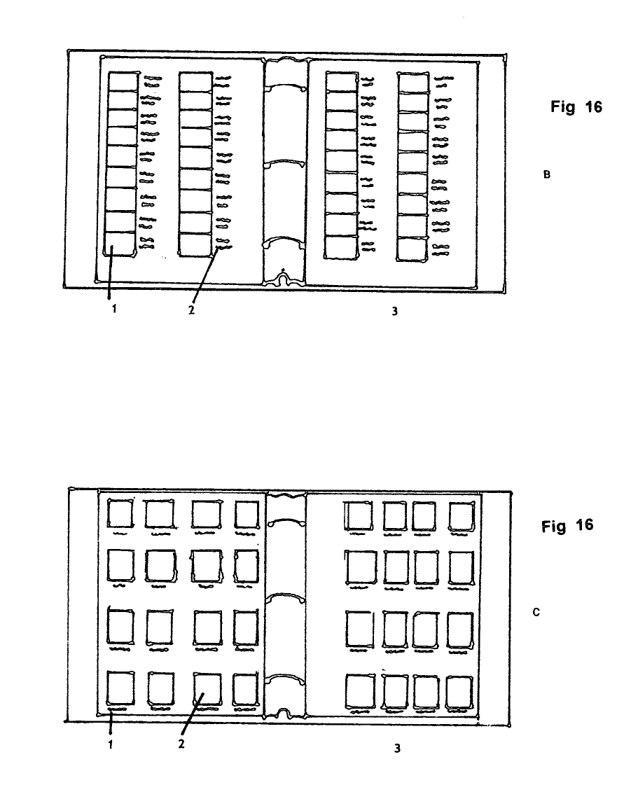

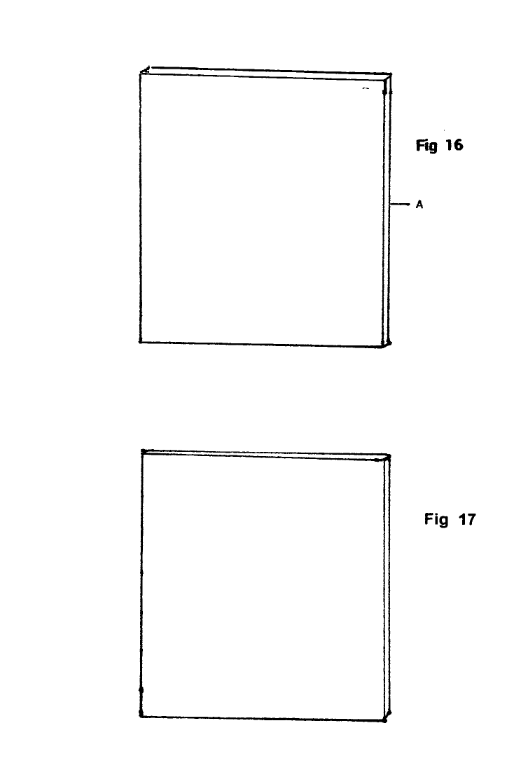

Binder #1 is a system act as a “hotel registry” a record keeper, FIGS. 16 A & B.

A small swatch (approximately 1″×1″) of each distinctive felt piece is cut and mounted in the binder FIG. 16 B 1 & FIG. 21 Each swatch has a name and a number FIG. 16 2. These correspond to the matching cell bed. In FIG. 16 C the figure shows where the name and photo of student is labeled with name and number of swatch FIG. 16 C 1 & 2. Next to student names/photos and class period there is a place for the name of their bed. FIGS. 17 A 1 & 2 and FIGS. 17 B 1 & 2. Each student in a class has a bed assigned to them. The binder is designed to make it easy and quick for the average teacher to use. Regular attendance sheets (with photo) are helpful in setting up the registry. This gives the teacher a reference if a phone is forgotten or a wrist band is misplaced. Through visual cues, the teacher will quickly come to associate student with bed felt color and fabric design as they are all very unique. Binder #2 contain: background for classroom teachers and administrators (FIG. 17).

The binder contains articles, essays, and anecdotes. There is a substantial amount of current research on the effects of distractions and learning. Much research has been completed, but there are still many questions about the effect modem technology may have on the human brain, particularly the young brains of our students. Studies from PEW Research Center and other University Research Centers are included making the contents of this binder not only interesting but the teacher can use this information directly with his or her students, to help them understand the importance of limiting distractions while learning. There is a summary of the current research as well as essays and anecdotal accounts of cell phone distractions.

Together, the components of this kit, will give the average classroom teacher, an easy and proactive way to quiet the distraction brought on by the cell phone. The students will quickly learn what out-of-sight, out-of-mind really means, as they are asked to exercise self control.

A good teacher takes every opportunity to model the behaviors and concepts he/she is promoting to the class.

### BACKGROUND OF INVENTION

Over the last decade, there has been a growing need for a proactive system to address cell phone distractions as they are presented in the classroom. The Cell Hotel is designed as a proactive way to address the issue of distractions in the classroom without alienating the students. The classroom teacher can now be completely even-handed about the management of cell phones and the distractions they produce.

Young people, in particular, are growing up dependent on these devices to keep in touch, listen to music, watch video, take pictures, appease boredom and yes, sometimes to do schoolwork. Optimally, The Cell Hotel is used by each teacher, as the curriculum demands. School wide use would certainly curtail much of the negative behavior regarding personal cell phone use during instructional periods.

Research has shown that students who multi-task (for ex.responding to and answering incoming text messages while studying or working on assignments); take longer to complete a task and do not learn the material as well as a student who has done the work over a sustained period of time with full attention. Excessive use of the cell phone has been correlated with lower grades. Students might be expected to keep their phones put away during class, but many show an inability to control their impulses with the device when it is near enough to grasp. The “New Marshmallow Test” refers to research demonstrating that students could not sustain their attention for more than 15 minutes without giving in to distraction from phone or social networking sites.

Advertising is directed at students during school hours, which costs the taxpayer. Phone companies are generating revenue from these young customers during instructional time.

The Cell Hotel is designed for teachers and students in a classroom setting. There may be other settings where The Cell Hotel would benefit the organization or event. Once the students have experienced the hotel check-in, check-out system, they will appreciate the security of the system and . . .

As the Cell Hotel becomes a new norm in classrooms, students will become aware of the improvement in their focus and the overall classroom climate. Parents and friends will find it pointless to be the source of distraction during class time. The teacher will enjoy a classroom of much fewer disruptions. The principal will enjoy fewer referrals and fewer angry parents. The teacher will gain substantial control over classroom distractions originating from cell phones. The cell phone and the technological revolution of the past decade has radically changed the school environment. Many teachers report student cell phones can interfere with a smoothly run classroom. The students are hooked up, instant gratification has become an expectation, and focusing on school work becomes the last thing on the student's mind. With personal phones and texting, gossip, drama, and bullying become louder and that translates into major distractions.

The relationship between teacher and student has become contentious over electronic distractions. If the teacher follows school rules and confiscates, chances are good the teacher will be faced with tears, harassment, and even physical threats; and, chances are that the relationship between the teacher and the said student is altered, and whatever the teacher offers from here on out will be rejected by said student.

Students will clean-up their workspace to the teachers standards; the student now has two free hands to put things away. Teacher may choose to keep phones stored in the Hotel until cleanup or other other task are complete to the teachers satisfaction.

Teachers will be assured that their students are working safely and free of distractions that cause accidents in Chemistry, Woodshop, Art, Welding, and Home Economics.

Less time will be afforded to students for cheating and harassing others during school hours. No more opportunity to photograph tests! However teacher is free to dole out the phones at his or her discretion. Students do use phones for practical school related reasons like taking photos of upcoming assignment dates, blogging assignments, etc.

Upon school wide adoption and implementation of the Cell Hotel, students will find a new consistency of classroom management procedures as they accept this as regular classroom protocol. The integrity of instructional periods lost to these distractions, will be restored. and . . . we may even see across-the-board improvement in time on task, improved attention span, higher G.P.As, less remediation and retention, and improved graduation rates. There will be less time for cyberbullying, and less risk of an accident in shop classes. Student cell phones must be dealt with if we are to improve our schools. Teachers want a method that is quick, safe, and secure, and, most importantly a method that does not anger or alienate the student. The teacher should be wearing her wristband as a sign to the student the system is used by everyone in the room.

What is claimed is:

1. a self-contained kit comprising of 40 cellphone beds with matching wristbands; said beds/wristbands are distinctive in color and print. Kit also contains 2 chargers with numerous adaptors. Contents of kit is contained in a sturdy and secure carrying case.
(a) The kit in claim 1. can be latched and locked for security. Limits liability to teacher and ensures the student that the phone will not be lost, stolen, or tampered with.
(b) The kit of claim 1. can be quickly and safely moved. Classrooms of students must sometime evacuate or switch work areas. The case is easily transported to any new location.
(c) The 40 cell phone beds and wrist bands of claim 1. are made from recycled bottles and are anti-microbial.

2. The solar chargers of claim 1. are charged by solar energy. The charger can also be charged by an ordinary outlet.

3. Said kit as described in claim 1. also includes a teacher binder which will serve as the record for bed and wristband assignment. A second binder contains research articles on the topics related to learning and distractions
